(19) United States
(12) Patent Application Publication
(10) Pub. No.: US 2021/0356552 A1
(43) Pub. Date: Nov. 18, 2021

(54) INFORMATION PROCESSING APPARATUS, SENSING SYSTEM, METHOD, PROGRAM, AND RECORDING MEDIUM

(71) Applicant: NEC Corporation, Minato-ku, Tokyo (JP)

(72) Inventor: Jun SAKAI, Tokyo (JP)

(73) Assignee: NEC Corporation, Minato-ku, Tokyo (JP)

(21) Appl. No.: 17/282,497

(22) PCT Filed: Oct. 8, 2019
(86) PCT No.: PCT/JP2019/039626

§ 371 Date: Apr. 2, 2021

(30) Foreign Application Priority Data
Oct. 15, 2018 (JP) 2018-194397

(51) Int. Cl. G01S 5/06

(52) U.S. Cl. CPC G01S 5/06

(57) ABSTRACT

The present disclosure provides a mechanism for making it possible to efficiently determine an optimal configuration set for one or more sensors for use for estimating the state of an object. Information processing apparatus is provided, which includes an obtaining unit configured to obtain a spatial distribution model of accuracy of estimation related to a state of an object, performed using one or more sensors, a calculation unit configured to calculate a representative statistic for evaluating the accuracy of estimation based on the spatial distribution model obtained, and an optimization unit configured to determine an optimal set of sensor configurations for the one or more sensors based on representative statistics calculated respectively for different sets of sensor configurations for the one or more sensors.

### BACKGROUND

### Technical Field

The present disclosure relates to information processing apparatus, a sensing system, a method, a program, and a recording medium.

### Background Art

The development of sensing technology and communication technology has made it possible to estimate various states of sensing objects based on sensing results from sensors arranged in a target space in a distributed fashion. For example, by measuring the strength and the direction of arrival of received signals at radio receiving stations arranged at a plurality of different points, it is possible to identify sources transmitting illegal electromagnetic waves in the target space. In the event a disaster occurs, rescue operations can be expedited by detecting signals transmitted from the devices of the victims. In marine surveillance activities (for example, detection of submarines) or fishing (for example, detection of groups of fish), the locations and the speed of movement of sound sources can be estimated by listening to sound waves. Satellites such as meteorological satellites or reconnaissance satellites estimate the state of some object by observing signals (including visible or infrared light) that arrive from the ground surface or from the atmosphere.

For example, NPTL 1 introduces the least squares estimation, maximum likelihood estimation method and Bayesian estimation as parametric location estimation methods, and shows the time of arrival (ToA), the angle of arrival (AoA) and the received signal strength of signals as metrics that can be used for the measurement. PTL 1 discloses an example of a technology for estimating the location of a transmitter based on the results of measuring the received signal strength of electromagnetic waves transmitted from the transmitter, at multiple points.

### CITATION LIST

### Non-Patent Literature

[NPTL 1] Shinsuke Hara, “Statistical Estimation Theory in Localization”, Institute of Electronics, Information and Communication Engineers, Engineering Sciences Society, IEICE Fundamentals Review, Vol. 4 No. 1, pp. 32-38, July, 2010.

### PATENT LITERATURE

[PTL 1] JP2017-142180 A

### SUMMARY

### Technical Problem

However, no method is presently known that makes it possible to efficiently design the configurations of sensors arranged in a target space for state estimation. For example, the combination of the configurations of sensors, including their (two-dimensional or three-dimensional) locations, orientations, receiving sensitivities and signal amplification factors influences the accuracy of state estimation (for example, estimation of the locations of wave sources), and also has a spatial bias in the accuracy of estimation. Speaking of the locations of sensors, for example, assuming that the number of sensors is fixed, if a plurality of sensors are located too close to each other, the individuality between sensors may be damaged, and the accuracy of estimation on the whole might deteriorate. Also, even if sensors are spaced at equal intervals, the distribution of accuracy of estimation can change depending on whether the sensors are arranged linear or grid-like. For example, in case the shape of the target space is complex, such as might happen in urban areas or narrow sea areas, it is not always optimal to simply distribute the sensors evenly. Heretofore, the combination of sensor configurations has often been determined based on the designer's rules of thumb, or through trial and error. However, such work is not efficient, and it might occur that only non-optimal solutions can be obtained.

The present disclosure has been prepared in view of the above-described problems, and it is therefore an object of the present disclosure to provide a mechanism for determining an optimal set of configurations of one or more sensors for use for estimating the state of an object.

### Solution to Problem

According to one example aspect, information processing apparatus is provided, which includes an obtaining unit configured to obtain a spatial distribution model of accuracy of estimation related to a state of an object, performed using one or more sensors, a calculation unit configured to calculate a representative statistic for evaluating the accuracy of estimation based on the spatial distribution model obtained, and an optimization unit configured to determine an optimal set of sensor configurations for the one or more sensors based on representative statistics calculated respectively for different sets of sensor configurations for the one or more sensors. Furthermore, a sensing system to include the one or more sensors, estimation apparatus configured to estimate the state of the object using the one or more sensors, and the information processing apparatus may be provided.

Also, according to another example aspect, a method is provided, which includes obtaining a spatial distribution model of accuracy of estimation related to a state of an object, performed using one or more sensors, calculating a representative statistic for evaluating the accuracy of estimation based on the spatial distribution model obtained, and determining an optimal set of sensor configurations for the one or more sensors based on the representative statistics calculated respectively for different sets of sensor configurations for the one or more sensors.

Also, according to another example aspect, a computer program is provided, which causes a processor to execute obtaining a spatial distribution model of accuracy of estimation related to a state of an object, performed using one or more sensors, calculating a representative statistic for evaluating the accuracy of estimation based on the spatial distribution model obtained, and determining an optimal set of sensor configurations for the one or more sensors based on the representative statistics calculated respectively for different sets of sensor configurations for the one or more sensors. Furthermore, a non-transitory computer readable recording medium to store the computer program may be provided.

### Advantageous Effects of Invention

According to the technique of the present disclosure, it is possible to efficiently determine an optimal set of configurations of one or more sensors for use for estimating the state of an object. Note that the technique according to the present disclosure may bring about, instead of this advantageous effect, or with this advantageous effect, other advantageous effects as well.

### BRIEF DESCRIPTION OF THE DRAWINGS

FIG. 1 is a schematic diagram to show an example of the configuration of a sensing system;

FIG. 2 is a flowchart to show an example of a schematic flow of a process that may be performed by the technique according to the present disclosure;

FIG. 3 is a block diagram to show an example of the configuration of design support apparatus according to the first example embodiment;

FIG. 4 is a flowchart to show an example of the flow of an optimal configuration determining process that may be performed by the design support apparatus according to the first example embodiment;

FIG. 5 is an exemplary graph to show the relationship between the source-sensor distance and the received strength, in a location estimation scenario;

FIG. 6 is an explanatory diagram for explaining an example of the location estimation scenario;

FIG. 7 shows an example of a map of accuracy of estimation based on an initial sensor configuration set, in the example described with reference to FIG. 6;

FIG. 8 shows an example of a sensor arrangement search result when the average value is selected as a representative statistic, in the example described with reference to FIG. 6;

FIG. 9 shows an example of a sensor arrangement search result when the maximum value is selected as a representative statistic, in the example described with reference to FIG. 6;

FIG. 10 is a block diagram to show an example of the configuration of design support apparatus according to a second example embodiment;

FIG. 11 is a flowchart to show an example of the flow of a number determining process that may be performed by the design support apparatus according to the second example embodiment; and

FIG. 12 shows an example of the result of performing the number determining process.

### DESCRIPTION OF THE EXAMPLE EMBODIMENTS

Hereinafter, example embodiments according to the present disclosure will be described in detail with reference to the accompanying drawings. Note that, in the Specification and the drawings, elements that can be described in the same or similar terms will be assigned the same reference signs, and overlapping description may be omitted.

The description will be given in the following order:

1. System Overview
1-1. Example of System Configuration
1-2. Description of Problems
1-3. Basic Principles

2. First Example Embodiment
2-1. Configuration of Design Support Apparatus
2-2. Process Flow
2-3. Example

3. Second Example Embodiment
3-1. Configuration of Design Support Apparatus
3-2. Process Flow
3-3. Example

4. Summary

### 1. System Overview

In this section, an outline of a sensing system, to which the technique according to the present disclosure is applicable, will be described first, and then the related problems and the basic principles of the technique according to the present disclosure will be described.

### 1-1. Example of System Configuration

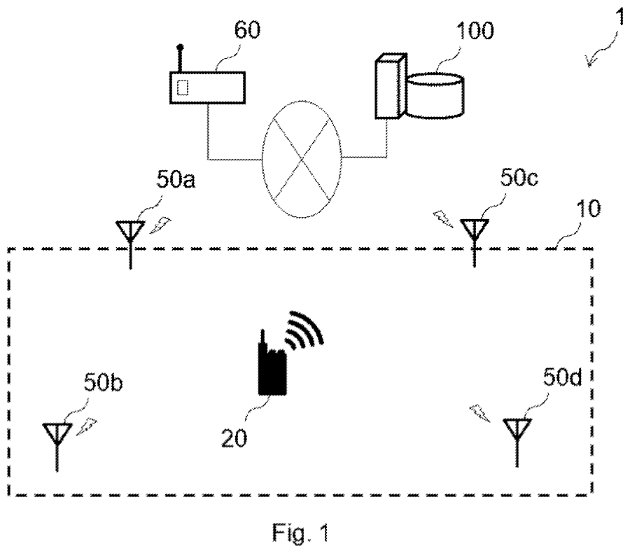

FIG. 1 is a schematic diagram to show an example of the configuration of the sensing system. Referring to FIG. 1, the sensing system 1 includes sensors 50a, 50b, 50c and 50d, an estimation server 60, and design support apparatus 100. FIG. 1 shows four sensors 50a, 50b, 50c and 50d, but the present disclosure is by no means limited to this example. That is, the sensing system 1 may include any number of sensors. In the following description, unless there is a need to distinguish between a plurality of sensors from each other, these sensors will be collectively referred to as “sensor(s) 50”, by omitting the alphabet at the end of the reference signs.

FIG. 1 also shows a target space 10 surrounded by a broken line, and an estimation object 20 that is present in the target space 10. The target space 10 is a finite space in the real world. For example, the target space 10 may correspond to a specific geographical area, and the estimation object 20 may be a device (also referred to as a “transmission source” or an “interference source”) transmitting illegal electromagnetic waves in that geographical area. In another example, the target space 10 may correspond to a space in which a disaster has occurred and there may be victims, and the estimation object 20 may be a device a victim holds, or may be a victim himself/herself. In yet another example, the target space 10 corresponds to an area subject to marine surveillance, and the estimation object 20 may be a ship or a warship operating in that surveillance-target area. The estimation object 20 may be any device that actively transmits radio signals such as electromagnetic waves (including light) or sound waves, or may be an object that passively reflects incoming radio signals. The device referred to herein may be any type of device, such as a mobile device (which may be, for example, user equipment, a mobile router, a smartphone, a mobile phone, or a beacon transmitter), a wearable device, a vehicle-mounted device, or a stationary device (for example, a radio base station or a relay station).

Any number of estimation objects 20 may be present in the target space 10. At any one point in time, there may be no estimation objects 20 in the target space 10. For the sake of simplicity, the following description will assume that one estimation object 20 is present in the target space 10, as shown in FIG. 1, but this is by no means limiting.

A sensor 50 is a piece of apparatus that performs sensing for estimation regarding the state of the estimation object 20 that is present in the target space 10. Note that the terms “sensing” and “measurement” will be used interchangeably herein. For example, the sensor 50 may be a radio receiver having an antenna for detecting the electromagnetic waves that arrive from the estimation object 20. In another example, the sensor 50 may be detection apparatus with a sonar that detects sound waves that arrive from the estimation object 20. The sensor 50 may detect radio signals passively, or may actively emit search signal into the target space 10 and detect the reflected waves reflected from the estimation object 20. The sensor 50 may be fixedly installed inside or near the target space 10, may be capable of moving (for example, a vehicle equipped with an antenna), or may be portable. The sensor 50 outputs measurement data to indicate index values such as the received signal strength, the time of arrival or the angle of arrival of detected signals.

The sensor 50 includes a communication interface (not shown) for wireless or cable communication. The sensor 50 receives commands related to sensing from the estimation server 60, and transmits measurement data to the estimation server 60, via the communication interface. The sensor 50 may be also capable of communicating with the design support apparatus 100 via the communication interface.

The estimation server 60 is server apparatus to be connected with one or more sensors 50. The estimation server 60 is configured to estimate the state of the estimation object 20 using one or more sensors 50. To be more specific, the estimation server 60, for example, transmits command signals related to sensing to the sensor 50, and receives the above-described measurement data from the sensor 50. Then, based on the measurement data received, the estimation server 60 performs state estimation regarding the state of the estimation object 20. For example, the estimation server 60 may estimate the location of the estimation object 20 (for example, the geographical location specified by the latitude and longitude, the two-dimensional location in the local coordinate system of the target space 10, or the three-dimensional location including the altitude or depth in addition to the two-dimensional location). This example is by no means limiting, and the estimation server 60 may estimate any state of the estimation object 20, including its moving speed, signal transmission level and so forth.

### 1-2. Description of Problems

The estimation server 60 estimates some state of the estimation object 20 based on the measurement data output from the sensor 50, using existing state estimation techniques such as the least squares estimation method, the maximum likelihood estimation method, or Bayesian estimation. The accuracy of state estimation depends on sensor configurations. For example, the combination of the configurations of sensors 50, including their (two-dimensional or three-dimensional) locations, orientations, receiving sensitivities and signal amplification factors influences the accuracy of state estimation, and also has a spatial bias in the accuracy of estimation. Speaking of the locations of sensors, for example, assuming that the number of sensors is fixed, if a plurality of sensors are located too close to each other, the individuality between sensors may be damaged, and the accuracy of estimation on the whole might deteriorate. Also, even if sensors are spaced at equal intervals, the distribution of accuracy of estimation can change depending on whether the sensors 50 are arranged linear or grid-like. Furthermore, for example, in case the shape of the target space 10 is complex, such as might happen in urban areas or narrow sea areas, it is not always optimal to simply distribute the sensors 50 evenly. Heretofore, the combination of the configurations of sensors 50 has often been determined based on the designer's rules of thumb, or through trial and error. However, such work is not efficient, and it might occur that only non-optimal solutions can be obtained.

Also, when determining the combination of sensor configurations based on the rules of thumb or through trial and error, it is difficult to properly evaluate the spatial distribution of accuracy of estimation over the entire target space 10. For example, even if some sample points show good accuracy of estimation, the accuracy of estimation may be poor at other points. Depending on the application of state estimation, higher accuracy of estimation may be desired in a specific area (for example, an important area) in the target space 10 than in the other areas. It is known as a rule of thumb that high accuracy of estimation can be achieved by arranging sensors densely in a certain area, but there is no method at present for evaluating whether or not this arrangement is appropriate objectively and quantitatively.

In addition, there is a trade-off between the number of sensors to arrange and the cost of deploying the system. If the number of sensors is increased for improved accuracy, the cost will increase. In order to achieve both sufficient accuracy of estimation and a reasonable cost, it is important to properly select the number of sensors and properly configure a limited number of sensors.

In some of the example embodiments described herein, the design support apparatus 100 is introduced into the sensing system 1 in order to solve or mitigate at least one of these problems. The design support apparatus 100 is information processing apparatus that supports the design of the configurations of one or more sensors 50 in the sensing system 1. The design support apparatus 100 determines an optimal sensor configuration set for use for estimating the state of an estimation object 20, following the principles described in the next section. A sensor configuration set refers to a set of sensor configurations that are applied to each of the sensors 50 involved in state estimation. The sensor configurations include at least one parameter that influences the accuracy of state estimation. For example, the sensor configurations may include at least one of the two-dimensional or three-dimensional location, orientation, receiving sensitivity, and signal amplification factor of the sensors 50. FIG. 1 shows an example in which the design support apparatus 100 is a piece of apparatus that is physically separate from the estimation server 60, but this example is by no means limiting, and the design support apparatus 100 may be integrated with the estimation server 60.

### 1-3. Basic Principles

Assume that the estimation object 20 is located at a location Φ in the target space 10. The sensors 50 performs sensing to generate measurement data (sensing result), and transmits the measurement data to the estimation server 60 via the communication interface. It may be possible to say that the state estimation the estimation server 60 performs is a problem of estimating the state S(Φ) of the estimation object 20 from the measurement data M(Φ), which depends on the location Φ of the estimation object 20 in the target space 10.

Here, assume that the number of sensors 50 involved in state estimation is N, and the number of parameters included in the sensor configurations of one sensor 50 is K. Also, assuming that a predetermined sensor configuration set X_{NK} is provided, the measurement data that is output from the N sensors 50 is a function of the location (F of the estimation object 20 and the sensor configuration set X_{NK}. However, here, for ease of explanation, the notation “X_{NK}” will be omitted, and the measurement data to be output from the N sensors 50 will be represented as “M(Φ)=[m₁(Φ), m₂(Φ), . . . , m_{N}(Φ)]”, assuming that it is a function of the location Φ alone. Also, the state of the estimation object 20 will be represented as “S(Φ)”. Note that the effect of the sensor configuration set X_{NK} will be discussed later.

Since measurement data usually contains errors, the accuracy of estimation of the state S(Φ) depends on the accuracy of measurement data M(Φ). The accuracy of the measurement data M(Φ) is evaluated, for example, by the expected value of the mean square error. Assuming the measurement data M(Φ) has the values of unbiased estimates that are evenly distributed around the true value, the expected value of the mean square errors of the measurement data M(Φ) equals the variance of M(Φ). The lower bound of the variance of M(Φ) can be determined based on the Cramer-Rao theorem. To be more specific, if the measurement data mₙ(Φ) of the n-th sensor 50 follows the probability density distribution pₙ(m|Φ), the lower bound value σ_{CRLB_n} of the variance σₙ of mₙ(Φ) fulfills the following equation:

$$\begin{matrix}[ Math . 1 ] & \\ {σ}_{CRLB \_ n}^{2} = \frac{1}{{I}_{n} ( ϕ )} = \frac{1}{E [ {( \frac{\partial log {p}_{n} ( m \vert ϕ ) \vert}{\partial ϕ} )}^{2} ]} & ( 1 )\end{matrix}$$

Here, E[·] represents the expected value. Iₙ(Φ) is the Fisher information. Equation 1, also referred to as the formula for the Cramér-Rao lower bound, indicates the theoretical limit of the accuracy of measurement data mₙ(Φ) from the n-th sensor 50 (that is, the measurement error cannot be expected to be less than this value).

Furthermore, assuming that the measurement errors of N sensors 50 are statistically independent of each other, the joint distribution l(Φ) of the measurement data M(( ) from the N sensors 50 is represented by the following equation:

[Math. 2]

l(ϕ)=p(m₁,m₂, . . . ,m_{N}|ϕ=Πₙ₌₁^{N}pₙ(mₙ|ϕ) (2)

By using the joint distribution I(Φ) of equation 2 over N sensors 50, instead of the probability density distribution pₙ(m|Φ) of equation 1, the spatial distribution model A(Φ) of the accuracy of the state estimation performed using these sensors 50 can be built as follows:

$$\begin{matrix}[ Math . 3 ] & \\ \begin{matrix}A ( ϕ ) = {σ}_{CRLB}^{2} = \frac{1}{I ( ϕ )} = \frac{1}{E [ {( \frac{\partial log l ( ϕ )}{\partial ϕ} )}^{2} ]} \\ = \frac{1}{E [ {( \frac{\partial log Π {p}_{n} ( m \vert ϕ )}{\partial ϕ} )}^{2} ]} = \frac{1}{E [ {( \frac{\partial \sum log {p}_{n} ( m \vert ϕ )}{\partial ϕ} )}^{2} ]}\end{matrix} & ( 3 )\end{matrix}$$

As understood from equation 3, by modeling the probability density distribution pₙ(m|Φ) of measurement data mₙ(Φ) of the sensors 50 in advance, the spatial distribution model of the accuracy of the state estimation performed using these sensors 50 can be built as a function of the location (D of the estimation object 20.

Next, the representative statistic f for evaluating whether the accuracy of estimation is good or poor is selected. The representative statistic may be, for example, the average value, the maximum value, the median or the percentile value (for example, the 90-th percentile value) of the accuracy of estimation over the entire target space 10. Instead, the representative statistic may be the average value, the maximum value, the median or the percentile value of the accuracy of estimation in a subspace in the target space 10 (for example, an important subspace where finer state estimation is desired). Furthermore, the representative statistic may be the weighted sum (or the weighted average) of representative values calculated for each of a plurality of subspaces in the target space 10. When the maximum value of the accuracy of estimation over the entire target space 10 is selected as the representative statistic, the representative statistic f is given by the following equation:

$$\begin{matrix}[ Math . 4 ] & \\ f = {max}_{ϕ} A ( ϕ ) & ( 4 )\end{matrix}$$

Note that, instead of the spatial distribution model A(Φ), a modified spatial distribution model A′(Φ), which may be modified as in the following equation, may be used. For example, in following equation 5, the target space 10 is divided into a first subspace (Φ∈T₁) and a second subspace (Φ∈T₂), and weights α₁ and α₂ are assigned to these subspaces, respectively:

[Math. 5]

A′(ϕ)=α₁A(ϕ|ϕ∈T₁)+α₂A(ϕ|ϕ∈T₂) (5)

Here, l(Φ), which is a factor of the spatial distribution model A(Φ) of equation 3, pₙ(m|Φ), and m are also functions of the sensor configuration set X_{NK}, as described earlier. When calculating the representative statistic f, the factor Φ disappears through the derivation of the representative value. As a result of this, the representative statistic f can be written as a function f(X) of the sensor configuration set X_{NK}.

The sensor configuration set to make this representative statistic f(X) the best value (usually the minimum value) is the optimal sensor configuration set. This problem of optimization can be represented as follows, for example, where the value of the k-th parameter of the sensor configurations of the n-th sensor is xₙₖ.

minimize f(X)

subject to xₙₖ∈Tₙₖ,

where X_{NK}=[xₙₖ] [Math. 6]

As a method for determining the solution of the optimization problem described above, an existing algorithm for a non-linear minimization problem with a limit value constraint of one objective variable can be used. For example, the Newton method, the quasi-Newton method, the BFGS (Broyden, Fletcher, Goldfarb and Shanno) method, the limited-memory BFGS method, or the conjugate gradient method may be used. Many of the algorithms use the derivative of f(X), which is a non-linear function, and find, for example, a solution in which the gradient vector ∇f(X) of f(X) becomes 0, while changing X according to some rule.

The design support apparatus 100 determines the optimal set of configurations of one or more sensors 50 for use for estimating the state of the estimation object 20 according to the principles described above.

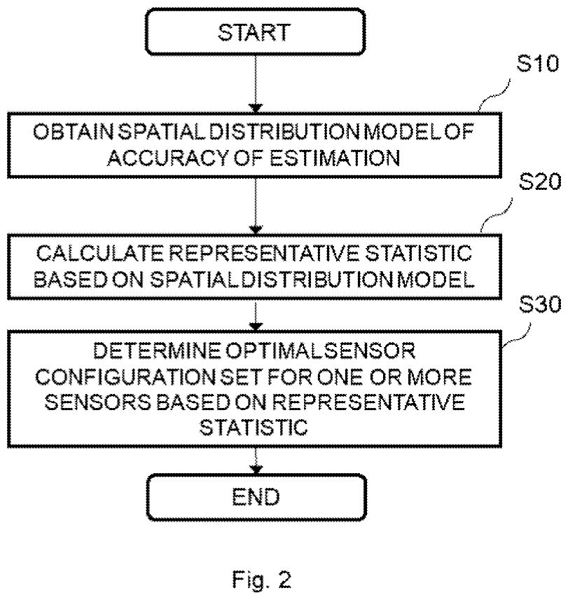

FIG. 2 is a flowchart to show an example of a schematic flow of a process that may be performed by the design support apparatus 100. Referring to FIG. 2, first, the design support apparatus 100 obtains a spatial distribution model of accuracy of estimation regarding the state of an object, performed using one or more sensors 50 (step S10). Next, the design support apparatus 100 calculates the representative statistic for evaluating the accuracy of estimation based on the spatial distribution model obtained (step S20). The design support apparatus 100 then determines the optimal sensor configuration set for one or more sensors, based on the representative statistics calculated respectively for a plurality of different sensor configuration sets for the one or more sensors 50 (step S30). The specific configuration and process of the apparatus that realizes this mechanism will be described in more detail in the following sections.

### 2. First Example Embodiment

### 2-1. Configuration of Design Support Apparatus

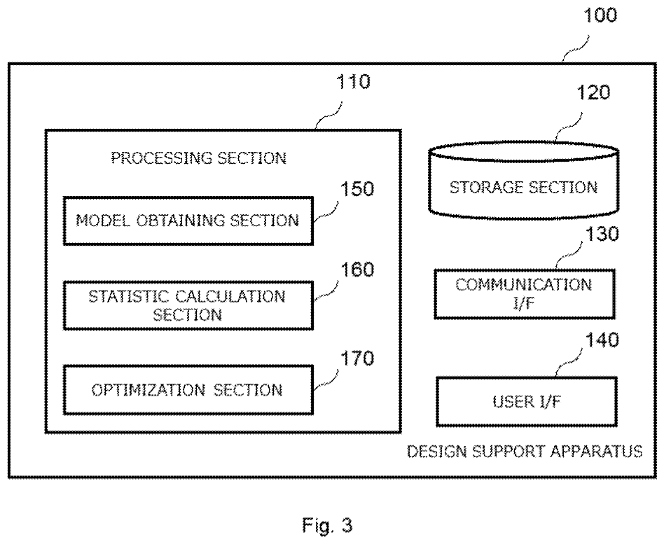

FIG. 3 is a block diagram to show an example of the configuration of the design support apparatus 100 according to the first example embodiment. Referring to FIG. 3, the design support apparatus 100 includes a processing section 110, a storage section 120, a communication interface (I/F) 130 and a user I/F 140.

The processing section 110 may include at least one processor, such as a CPU (Central Processing Unit), an MPU (Micro Processing Unit) or a microcontroller. The processing section 110 provides the design support apparatus 100 with logical functions, which will be described later in detail, by executing the computer programs stored in the storage section 120.

The storage section 120 includes temporary and non-temporary computer-readable memories. The temporary memory may include, for example, a RAM (Random Access Memory). The non-temporary memory may include, for example, one or more of a ROM (Read Only Memory), an HDD (Hard Disk Drive), and an SSD (Solid State Drive). The storage section 120 stores computer programs for realizing the functions of the design support apparatus 100. The computer programs may be stored in the storage section 120 in advance, or may be downloaded from an external device as needed. The storage section 120 may also store various types of data for use in the operation of the design support apparatus 100.

The communication I/F 130 is an interface for mediating communication by the design support apparatus 100 with other pieces of apparatus. The communication I/F 130 may include, for example, an antenna for wireless communication, an RF (Radio Frequency) circuit, and a baseband circuit. Instead, the communication I/F 130 may include a connection terminal and a connection circuit for cable communication.

The user I/F 140 may include an input device for receiving commands or information input from the user and an output device for outputting information. The input device may include, for example, one or more of a keyboard, a keypad, a touch panel and a pointing device. The output device may include, for example, one or more of a display, a printer and a speaker.

Referring to FIG. 3, the processing section 110 includes a model obtaining section 150, a statistic calculation section 160 and an optimization section 170 as logical functional modules.

The model obtaining section 150 is configured to obtain a spatial distribution model of accuracy of estimation regarding the state of the estimation object 20, performed using one or more sensors 50. For example, the model obtaining section 150 obtains the spatial distribution model by building the spatial distribution model using a joint distribution of probability density distributions of measurement errors over a plurality of sensors 50. Typically, the spatial distribution model can be defined as a function of the location of the estimation object 20 that gives the lower bound of the variance of errors depending on the joint distribution. The model obtaining section 150 can obtain the spatial distribution model by building a spatial distribution model according to the above-mentioned equation 3 for a given sensor configuration set, for example.

The statistic calculation section 160 is configured to calculate the representative statistic for evaluating the accuracy of state estimation based on the spatial distribution model obtained in the model obtaining section 150. What type of statistic (for example, the average value, the maximum value, the median or the percentile value of the accuracy of estimation) the statistic calculation section 160 selects as the representative statistic may be specified by the user, for example, through a user interface (not shown), or may be determined in advance.

The optimization section 170 is configured to determine, based on the representative statistics calculated in the statistic calculation section 160 for each of a plurality of different sensor configuration sets for one or more sensors 50, the optimal sensor configuration set for the one or more sensors 50. The optimization section 170 may determine the optimal sensor configuration set by searching for the sensor configuration set that minimizes the representative statistic by using, for example, any of the previously-described algorithms for solving the optimization problem. The search for the optimal sensor configuration set may include, for example, initializing the sensor configuration set, repeating calculating the representative statistic with the range of each sensor configuration parameter as the search range, and determining the convergence of the representative statistic.

### 2-2. Process Flow

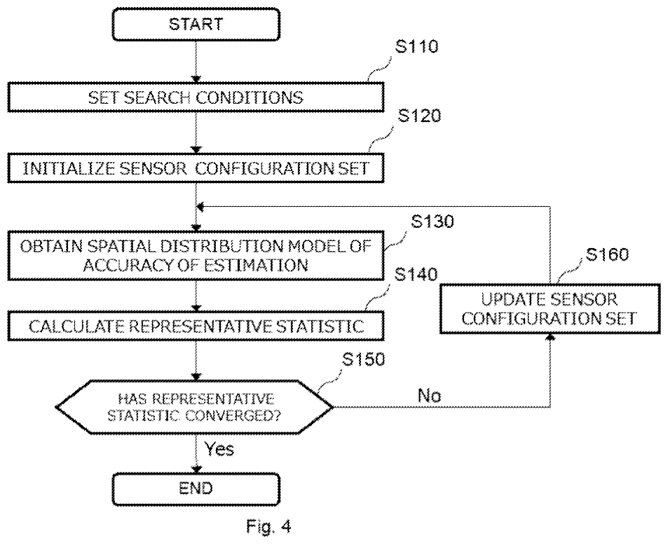

FIG. 4 is a flowchart to show an example of the flow of the optimal configuration determining process that may be performed by the design support apparatus 100 according to the first example embodiment.

First, the optimization section 170 sets out the search conditions (step S110). For example, the search conditions includes the spatial range of the target space 10 and the number of sensors.

Next, the optimization section 170 initializes the sensor configuration set (step S120). The initial values of the parameters included in the sensor configuration set may have any values within the corresponding range.

Next, given the sensor configuration set initialized in step S120 or updated in step S160 (described later), the model obtaining section 150 obtains a spatial distribution model of accuracy of estimation regarding the state of the estimation object 20, performed using one or more sensors 50 (step S130).

Next, based on the spatial distribution model obtained in step S130, the statistic calculation section 160 calculates the representative statistic for evaluating the accuracy of state estimation (step S140).

The optimization section 170 determines whether or not the representative statistic, calculated in repetitions of steps S130 and S140, has converged (step S150). When it is determined that the representative statistic has converged, the optimization section 170 determines that the sensor configuration set upon the convergence is the optimal sensor configuration set, and outputs this optimal sensor configuration set as a result of the process. On the other hand, if it is not determined that the representative statistic has converged, the optimization section 170 updates the sensor configuration set (step S160), and make the model obtaining section 150 and the statistic calculation section 160 carry out the next repetition.

The optimal sensor configuration set determined by the design support apparatus 100 in this way may be applied to the sensors 50 in the sensing system 1, for example, through work by an operator who has viewed the configuration information (indicating the optimal sensor configuration set). Instead, if the configurations of the sensors 50 can be controlled remotely, for example, through a network, each sensor 50 may be configured automatically, based on configuration information to be output from the design support apparatus 100.

### 2-3. Example

To illustrate one scenario related to the first example embodiment, optimization of the three-dimensional locations of the sensors 50 when estimating the location of a transmission source that transmits electromagnetic waves in the sensing system 1 will be considered here.

In this scenario, the sensors 50 may correspond to radio receiving stations (radio wave sensors) having antennas for receiving electromagnetic waves. Each sensor 50 measures, for example, the received strength of electromagnetic waves received from a transmission source that is present in an unknown location Φ, and generates measurement data mₙ(Φ) to indicate the received strength. The sensors 50 are synchronized with each other in time, and each sensor 50 includes a time stamp to show the corresponding measurement time, in the measurement data mₙ(Φ). Then, each sensor 50 transmits the measurement data mₙ(Φ) to the estimation server 60. For example, the measurement data may be transmitted via a wireless connection such as a wireless LAN (Local Area Network) connection or a cellular connection (such as LTE (Long Term Evolution), LTE-A, 5G, etc.), or may be transmitted via a cable connection (for example, Ethernet connection).

The estimation server 60 estimates the location of a transmission source in the target space 10 based on the measurement data collected from one or more radio receiving stations. In this case, the transmission source's location F is the very state S(D) to be estimated. The design support apparatus 100 determines an optimal arrangement of the sensors 50 that can anticipate the best accuracy when the estimation server 60 carries out the location estimation. That is, the design support apparatus 100 optimizes the sensor configuration set comprised of the three-dimensional coordinates [xₙ₁, xₙ₂, xₙ₃] (n=1, . . . , N) of N sensors 50.

For example, a propagation model to represent the relationship between the propagation distance of electromagnetic waves and their received strength in the target space 10 is defined as follows:

[Math. 7]

\tilde{m}ₙ(ϕ)=α·dₙ(ϕ)^{-β}. (6)

where dₙ(ϕ)=\sqrt{(x−xₙ₁)²+(y−xₙ₂)²+(z−xₙ₃)²}

In equation 6, α is a coefficient associated with the transmission level of electromagnetic waves, and β is a parameter associated with the attenuation rate per unit distance. dₙ(Φ) represents the distance between the location [xₙ₁, xₙ₂, xₙ₃] of the n-th sensor 50 and the location Φ=[x, y, z] of the transmission source.

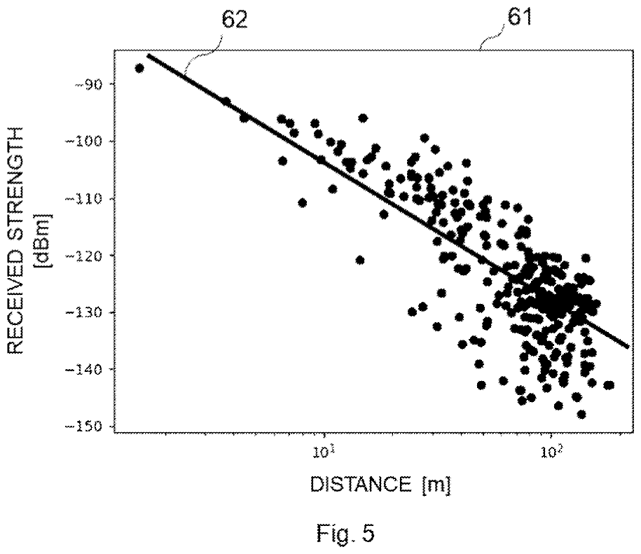

Here, assume that the sensors 50 receive electromagnetic waves transmitted at a certain transmission level from a large number of known transmission sources that are sampling distances apart, and, as a result of this, a graph 61 to show the relationship between the distance and the received strength as shown in FIG. 5. The horizontal axis in the graph 61 represents the distance between the known transmission sources and the sensors 50, and the vertical axis represents the received signal strength. The points plotted in the graph 61 correspond to respective measurement values. Then, the model parameters (propagation constants) a and R of the propagation model can be derived by analyzing the propagation model of equation 6 according to, for example, the least squares method so as to fit the set of the measurement values in the graph 61. The solid line 62 represents the propagation model determined by the derived model parameters a and.

Referring to the graph 61, the measurement values are distributed around the propagation model 62 with errors. One of the major causes of such errors is multipath fading in the propagation environment. That is, electromagnetic waves not only propagate from the transmission sources to the sensors 50 as direct waves, but are also reflected by buildings, the ground, moving vehicles and people, and propagate as reflected waves. Such various changes in the propagation environment, large and small, can be handled by modeling through a probability distribution.

When the measurement data that has been measured is normalized with values in accordance with the propagation model 62, a normalized probability density distribution of received strength is obtained. For example, the type of multipath fading environment in which a large number of scattered waves are received without a predominant direct wave is also referred to as “Rayleigh fading environment”, and it is known that the probability density distribution of a physical quantity to match the square of received strength observed in the Rayleigh fading environment becomes an exponential function. In another example, it is known that the probability density distribution of received strength observed in the Rayleigh fading environment with one standing wave added thereto becomes the Nakagami-Rice distribution. Here, for the sake of simplicity, a Rayleigh fading environment will be assumed for all the subregions of all sensors 50, and the following exponential probability density distribution will be used:

$$\begin{matrix}[ Math . 8 ] & \\ p ( {m}_{n} \vert ϕ ) = \frac{1}{m ( ϕ )} {e}^{( - \frac{{m}_{n}}{\tilde{m} ( ϕ )} )} & ( 7 )\end{matrix}$$

It may be possible to say that the probability density distribution of equation 7 represents the likelihood lₙ(mₙ|Φ) of the transmission source being present at the location Φ in the target space 10 when an electromagnetic wave is received from an unknown transmission source in the n-th sensor 50. When this is calculated for an arbitrary point in the target space 10, the likelihood distribution of the locations of transmission sources is derived for each sensor 50. Then, by multiplying the likelihood distributions of all the sensors 50, a joint likelihood distribution of the entire sensing system 1 can be obtained. The estimation server 60 can estimate, for example, that a transmission source is located at the point where the highest likelihood is shown in the joint likelihood distribution (which is also referred to as a “likelihood map”) of the target space 10.

Furthermore, by substituting the probability density distribution of equation 7 into equation 3, a spatial distribution model A(Φ) of the following accuracy of estimation can be obtained:

$$\begin{matrix}[ Math . 9 ] & \\ A ( ϕ ) = \frac{1}{E [ {( \frac{\partial \sum \frac{1}{m ( ϕ )} {e}^{( - \frac{{m}_{n}}{\tilde{m} ( ϕ )} )}}{\partial ϕ} )}^{2} ]} & ( 8 )\end{matrix}$$

Provided that equation 8 represents the lower bound of the variance of errors in location estimation when it is assumed that the estimation object 20 is present at the location Φ in the target space 10, the smaller that value, the better the accuracy of estimation that might be expected. When choosing the average value of the spatial distribution of accuracy of estimation as the representative statistic, the objective function of optimization can be represented as:

$$\begin{matrix}[ Math . 10 ] & \\ f ( X ) = {mean}_{ϕ} A ( ϕ , X ) & ( 9 )\end{matrix}$$

In this scenario, the design support apparatus 100 determines the sensor configuration set (to be more specific, the three-dimensional coordinates [xₙ₁, xₙ₂, xₙ₃](n=1, . . . , N) of N sensors 50) that minimizes the objective function of equation 9, in order to optimize the three-dimensional locations of the sensors 50.

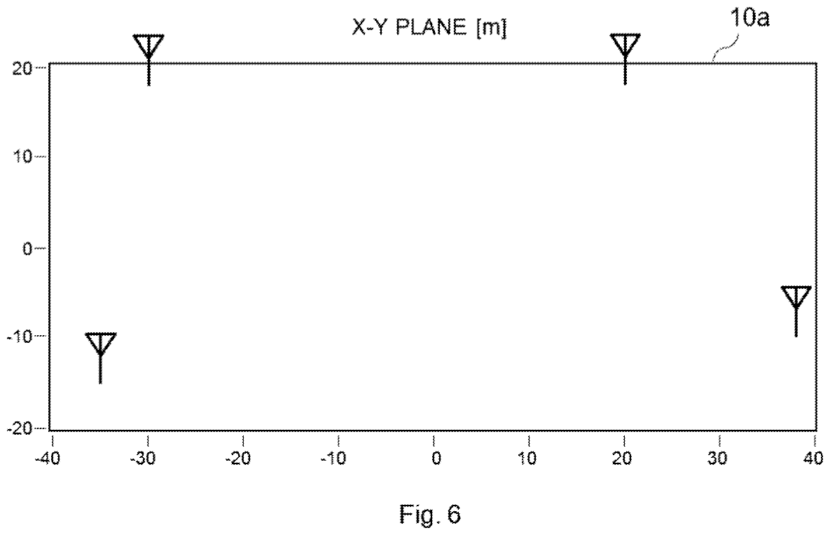

FIG. 6 is an explanatory diagram for explaining an example of the above-described scenario of location estimation. As shown in FIG. 6, for example, location estimation is performed using four sensors, in a target space 10a having a width of 80 m in the X direction and 40 m in the Y direction, in a two-dimensional X-Y coordinate system. The height is not considered here for ease of explanation. If there is no obstacle to block electromagnetic waves in the target space 10a, it is possible to assume that electromagnetic waves propagate in free space, and set the value of the model parameter β in equation 6 to β=2. Since the model parameter α disappears in later expansion of the equation, the value of the model parameter a needs not be taken into account. Assuming a Rayleigh fading environment as a multipath fading environment, the probability density distribution of estimation errors will be as follows:

$$\begin{matrix}[ Math . 11 ] & \\ {p}_{n} ( m \vert ϕ ) = \frac{1}{\tilde{m} ( ϕ )} {e}^{( - \frac{{m}_{n}}{\tilde{m} ( ϕ )} )} , where \tilde{m} ( ϕ ) = α \cdot {{d}_{n} ( ϕ )}^{- 2} & ( 10 )\end{matrix}$$

The design support apparatus 100, for example, using this probability density distribution, performs the optimal configuration determining process according to the principles described above. The initial values of the sensor configuration set may be determined randomly, and, for example, take the following values:

(x₁, y₁)=(−35, −15)

(x₂, y₂)=(−30, 18)

(x₃, y₃)=(20, 18)

(x₄, y₄)=(38, −10)

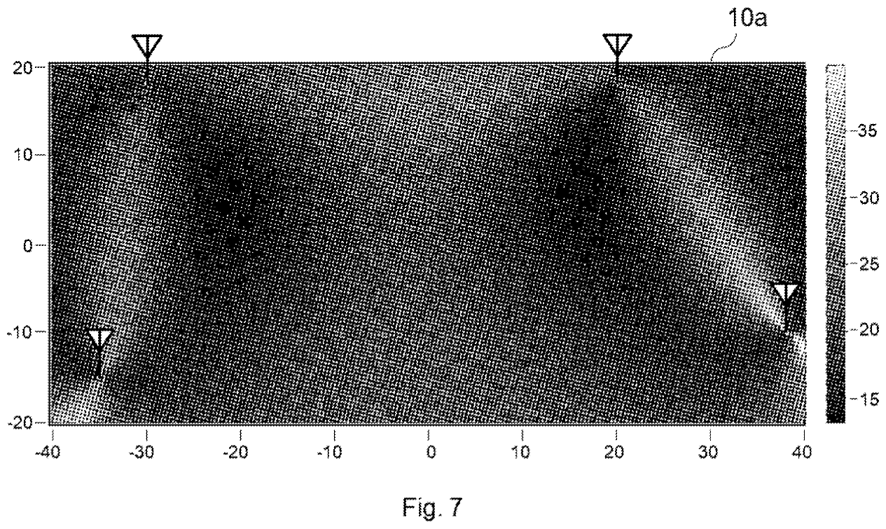

Next, when equation 10 is substituted in equation 8, a spatial distribution having an accuracy of estimation as shown in FIG. 7 is calculated. In this example, the standard deviation of the error of the accuracy of estimation at each point in the target space 10a is evaluated, and the higher the density of dots (the darker the color) in the map of FIG. 7, the better the accuracy of estimation that might be expected.

Next, the average value of the accuracy of estimation over the entire target space 10a will be illustrated as a first example of the representative statistic, and the maximum value of the accuracy of estimation over the entire target space 10a will be illustrated as a second example. In the case of FIG. 7, the average value of the accuracy of estimation is equal to 18.8 m, and the maximum value is equal to 40.9 m.

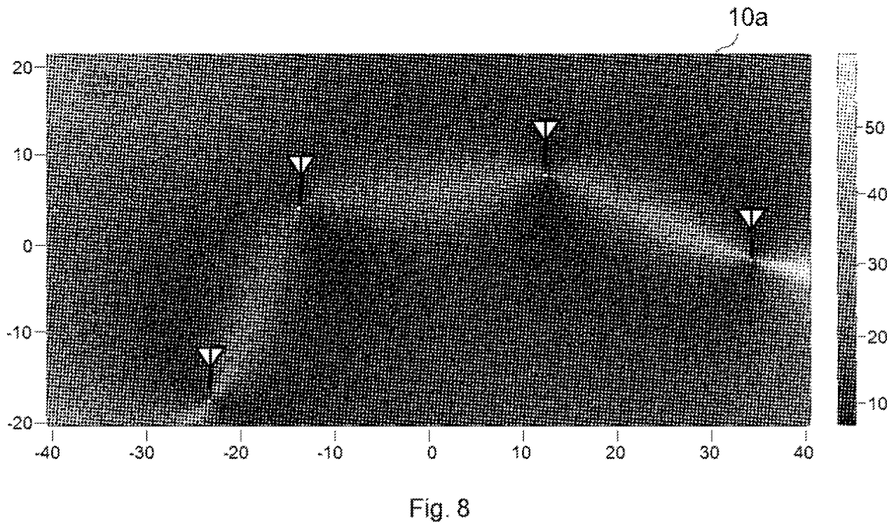

FIG. 8 shows an example of a search result of the sensor arrangement that minimizes the representative statistic when the average value is selected as the representative statistic (first example). Note that, in this case, the limited-memory BFGS method is used as the optimization algorithm. The arrangement of four sensors found as a result of the search was as follows:

(x₁, y₁)=(−23.0, −17.4)

(x₂, y₂)=(−13.6, 3.3)

(x₃, y₃)=(12.2, 7.0)

(x₄, y₄)=(33.8, −2.3)

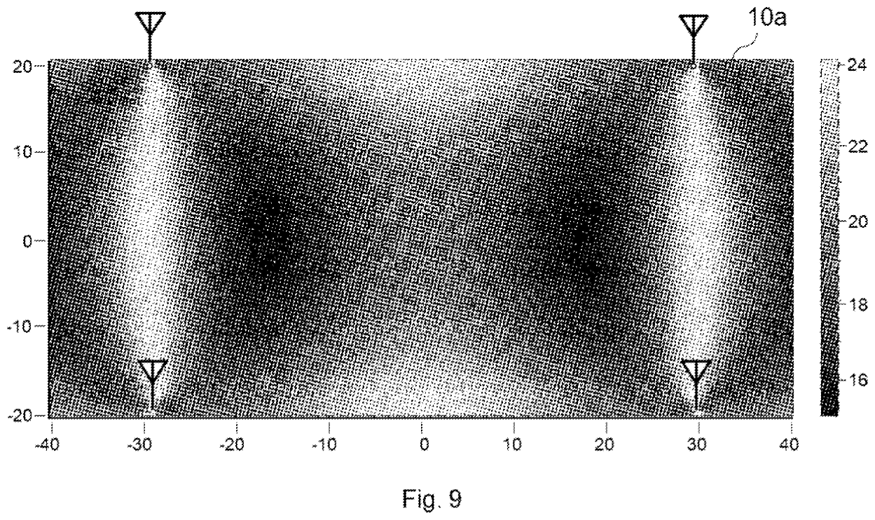

FIG. 9 shows an example of a search result of the sensor arrangement that minimizes the representative statistic when the maximum value is selected as the representative statistic (second example). Similar to the example in FIG. 8, the limited-memory BFGS method is used as the optimization algorithm. The arrangement of four sensors found as a result of the search was as follows:

(x₁, y₁)=(29.3, 19.3)

(x₂, y₂)=(−29.3, 19.3)

(x₃, y₃)=(29.3, −19.3)

(x₄, y₄)=(−29.3, −19.3)

Focusing on the average value of the accuracy of estimation, it is 14.7 m in the sensor arrangement of FIG. 8, whereas it is 19.0 m in the sensor arrangement of FIG. 9, so that it is clear that the sensor arrangement of FIG. 8 is better. By contrast with this, looking at the maximum value of the accuracy of estimation, it is 60.1 m in the sensor arrangement of FIG. 8, whereas it is 24.1 m in the sensor arrangement of FIG. 9, so that it is clear that the sensor arrangement of FIG. 9 is better.

As described above, according to the present example embodiment, it is possible to determine, objectively and quantitatively, the optimal sensor configuration set through analysis of errors in state estimation in the target space.

### 3. Second Example Embodiment

According to the first example embodiment, the design support apparatus 100 determines the optimal sensor configuration set, assuming that that a predetermined number of sensors are provided. Here, as mentioned earlier, considering that there is a trade-off between the number of sensors to be arranged and the cost of deploying the system, it would be effective to achieve both sufficient accuracy of estimation accuracy and a reasonable cost if the number of sensors can also be optimized. Therefore, this section will describe a mechanism for optimizing the number of sensors by using the principles described above.

### 3-1. Configuration of Design Support Apparatus

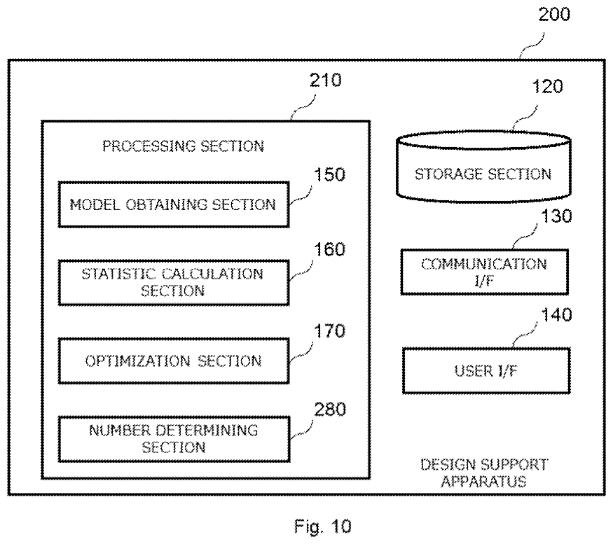

FIG. 10 is a block diagram to show an example of the configuration of the design support apparatus 200 according to the second example embodiment. The design support apparatus 200 can be used instead of the design support apparatus 100, in a system that is similar to the sensing system 1 described above with reference to FIG. 1. Referring to FIG. 10, the design support apparatus 200 includes a processing section 210, a storage section 120, a communication I/F 130 and a user I/F 140.

The processing section 210 may include at least one processor, such as a CPU, an MPU or a microcontroller. The processing section 210 provides the design support apparatus 200 with logical functions by executing the computer programs stored in the storage section 120. Referring to FIG. 10, the processing section 210 includes, as logical functional modules, a model obtaining section 150, a statistic calculation section 160, an optimization section 170, and a number determining section 280.

As described earlier, the model obtaining section 150 is configured to obtain a spatial distribution model of accuracy of estimation regarding the state of the estimation object 20, performed using one or more sensors 50. The spatial distribution model may be, for example, defined as a function (function of the location of the estimation object 20) that gives the lower bound of the variance of errors, and that is built using a joint distribution of probability density distributions of measurement errors over a plurality of sensors 50. The statistic calculation section 160 is configured to calculate the representative statistic for evaluating the accuracy of state estimation based on the spatial distribution model obtained in the model obtaining section 150. The optimization section 170 is configured to determine, based on the representative statistics calculated in the statistic calculation section 160 for each of a plurality of different sensor configuration sets for one or more sensors 50, the optimal sensor configuration set for the one or more sensors 50.

The number determining section 280 determines the minimum number of sensors that satisfy a predetermined condition regarding the accuracy of state estimation. Generally speaking, the larger the number of sensors to be arranged, the higher the accuracy of state estimation. On the other hand, arranging more sensors means higher cost. Therefore, the number determining section 280 determines the optimal number of sensors to arrange, by judging whether the representative statistics calculated in the statistic calculation section 160 (hereinafter referred to as “optimized representative statistics”), corresponding to the optimal sensor configuration sets determined in the optimization section 170 for each number of sensors, fulfils a predetermined criterion, while increasing the number of sensors by degrees. In this case, the number of sensors that first fulfills the criterion is the optimal number of sensors. For example, when the number of sensors “n” fulfills one of the following conditions or a combination of two or more conditions, n may be judged to be the optimal number:
The optimized representative statistic for the number of sensors n falls below a predetermined threshold (the smaller the representative statistic, the higher the accuracy of estimation);
The optimized representative statistic for the number of sensors n exceeds a predetermined threshold (the larger the representative statistic, the higher the accuracy of estimation); and
The difference between the optimized representative statistic for the number of sensors n and the optimized representative statistic for the number of sensors n+1 falls below a predetermined threshold.

### 3-2. Process Flow

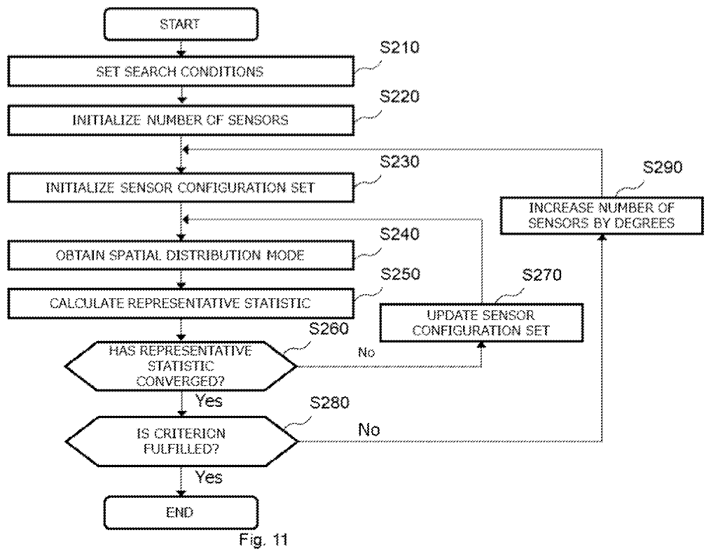

FIG. 11 is a flowchart to show an example of the flow of the number determining process that may be performed by the design support apparatus 200 according to the second example embodiment.

First, the optimization section 170 sets out the search conditions (step S210). For example, the search conditions includes the spatial range of the target space 10. Also, the number determining section 280 initializes the number of sensors (step S220). The number of sensors may be initialized to any value that is sufficiently small.

Next, the optimization section 170 initializes the sensor configuration set (step S230). The initial values of the parameters included in the sensor configuration set may have any values within the corresponding range.

Next, given the sensor configuration set initialized in step S230 or updated in step S270 (described later), the model obtaining section 150 obtains a spatial distribution model of accuracy of estimation regarding the state estimation performed using the number of sensors then (step S240).

Next, based on the spatial distribution model obtained in step S240, the statistic calculation section 160 calculates the representative statistic for evaluating the accuracy of state estimation (step S250).

The optimization section 170 determines whether or not the representative statistic, calculated in repetitions of steps S240 and S250, has converged (step S260). When it is determined that the representative statistic has converged, the optimization section 170 determines that the sensor configuration set upon the convergence is the optimal sensor configuration set for the number of sensors then. On the other hand, if it is not determined that the representative statistic has converged, the optimization section 170 updates the sensor configuration set (step S270), and make the model obtaining section 150 and the statistic calculation section 160 carry out the next repetition.

Next, the number determining section 280 determines whether the representative statistic (optimized representative statistic) corresponding to the determined optimal sensor configuration set fulfills a predetermined condition (for example, whether it falls below a predetermined threshold) (step S280). When it is determined that the predetermined condition is fulfilled, the number determining section 280 determines that the number of sensors then is optimal, and outputs the optimal number of sensors (and the corresponding sensor configuration set) as a result of the process. On the other hand, when it is determined that the predetermined condition is not fulfilled, the number determining section 280 increases the number of sensors by degrees (step S290), and makes the above-described steps S230 to S270 to be performed for the new numbers of sensors.

### 3-3. Example

As an example of the second example embodiment, a case of deriving the minimum value for the number of sensors that can anticipate an accuracy of estimation to satisfy a certain threshold level in the target space 10a described with reference to FIG. 6 will be described.

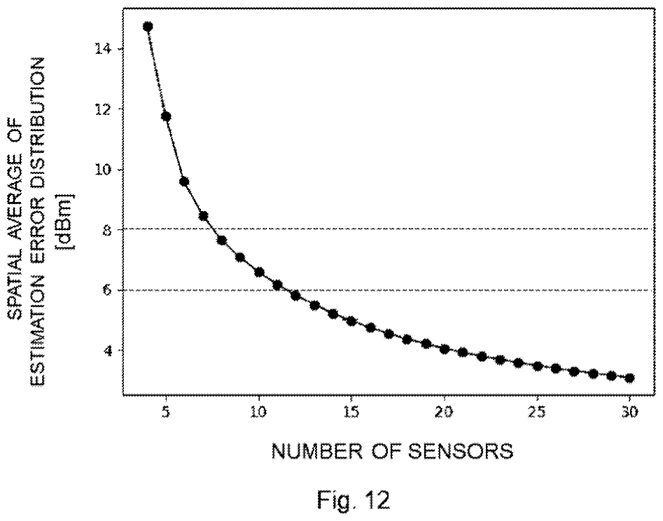

Since the value of the spatial distribution model A(Φ) shown in above equation 8 means the expected value of the variance of estimation errors, its square root can be seen as an index to show the accuracy of state estimation. For example, FIG. 12 shows a result of performing the number determining process described with reference to FIG. 11, by selecting 4 as the initial value of the number of sensors and selecting the average value as the representative statistic, for the target space 10a. The horizontal axis in FIG. 12 is the number of sensors, and the vertical axis is the optimized representative statistic. Here, the optimized representative statistic is the spatial average of the distribution of estimation errors. For example, when the criterion is given that the optimized representative statistic is less than 8 dBm, the optimal number of sensors is 8, according to the result of FIG. 12. Also, when the criterion is given that the optimized representative statistic is less than 6 dBm, the optimal number of sensors is 12, according to the result of FIG. 12.

In this way, according to the present example embodiment, the number of sensors to be arranged in the target space is optimized by analyzing the errors of state estimation in the target space, so that both sufficient accuracy of estimation and a reasonable cost for deploying the sensing system can be achieved.

### 4. Summary

Up to this point, a number of example embodiments of the technique according to the present disclosure have been described in detail with reference to FIG. 1 to FIG. 12. In the example embodiments described above, a representative statistic for evaluating the accuracy of estimation is calculated based on a spatial distribution model of accuracy of estimation for the state of an object, performed using one or more sensors, and an optimal sensor configuration set is determined based on representative statistics calculated for each of a plurality of different sensor configuration sets. According to this configuration, sensor configurations can be optimized more efficiently or automatically than when sensors are arranged based on rules of thumb or through trial and error when deploying the system.

In one example, a spatial distribution model of accuracy of estimation can be built using a joint distribution of probability density distributions of measurement errors across a plurality of sensors. Therefore, even in a situation where a large number of sensors are arranged to cover the target space, the optimal sensor configuration set can be determined based on objective and quantitative evaluation. This technique is also advantageous in that it can be used regardless of the shape of the target space.

Also, the spatial distribution model may be a function of the location of the estimation object, that gives the lower bound of the variance of errors depending on the joint distribution. In this case, it is possible to see the lower bound of the variance of errors as the expected value of the accuracy of estimation, and model the derivation of the optimal sensor configuration set into an optimization problem for optimizing the accuracy of estimation. Therefore, it is possible to implement the above-described mechanism on a computer by utilizing existing optimization algorithms.

In one example, the state of an estimation object may be the location of the estimation object. Therefore, the technique according to the present disclosure is used in a wide variety of situations of location estimation, including when identifying the transmission source of illegal electromagnetic waves, rescuing victims, detecting suspicious ships, detecting groups of fish, or observing the surface of earth via satellites.

In one example embodiment, the number of sensors to be arranged to estimate the state of an estimation object is further determined based on optimal sensor configuration sets that are determined respectively for different numbers of sensors. According to this configuration, it is possible to avoid the waste of arranging an excessively large number of sensors in order to achieve high accuracy of estimation, and configure a limited number of sensors properly. That is, it is possible to achieve both sufficient accuracy of estimation and a reasonable cost.

Note that the technique according to the present disclosure is by no means limited to the example embodiments described above. It will be understood by those of ordinary skill in the art that these example embodiments are simply examples, and that a variety of changes can be made without departing from the scope and spirit of the present disclosure.

For example, the process steps shown in the flowcharts do not necessarily have to be executed in the chronological orders illustrated. For example, the process steps may be executed in an order different from the order illustrated, or two or more process steps may be carried out in parallel. Also, some of the process steps may be deleted, or additional process steps may be added.

Also, the functions of the apparatus described in the Specification may be realized by software, by hardware, or by combining software and hardware. The program instructions of the computer programs constituting the software are, for example, stored inside in each piece of apparatus, or in an external computer-readable recording medium, read into a memory upon execution, and executed by processors.

Some of or all of the example embodiments can be described as in the following supplementary notes, but are by no means limited to the following.

### (Supplementary Note 1)

An information processing apparatus comprising:

an obtaining unit configured to obtain a spatial distribution model of accuracy of estimation related to a state of an object, performed using one or more sensors;

a calculation unit configured to calculate a representative statistic for evaluating the accuracy of estimation based on the spatial distribution model obtained; and

an optimization unit configured to determine an optimal set of sensor configurations for the one or more sensors based on representative statistics calculated respectively for different sets of sensor configurations for the one or more sensors.

### (Supplementary Note 2)

The information processing apparatus according to supplementary note 1, further comprising a number determining unit configured to determine the number of sensors to be arranged to estimate the state of the object, based on optimal sets of sensor configurations determined respectively for different numbers of sensors.

### (Supplementary Note 3)

The information processing apparatus according to supplementary note 2, wherein the number determining unit is configured to determine whether the representative statistic corresponding to the optimal set of sensor configurations determined for each number of sensors fulfills a predetermined condition, to determine the number of sensors to be arranged.

### (Supplementary Note 4)

The information processing apparatus according to any one of supplementary notes 1 to 3, wherein the obtaining unit is configured to build the spatial model using a joint distribution of probability density distributions of measurement errors across a plurality of sensors, to obtain the spatial model.

### (Supplementary Note 5)

The information processing apparatus according to supplementary note 4, wherein the spatial distribution model is a function of a location of the object to give a lower bound of variance of errors depending on the joint distribution.

### (Supplementary Note 6)

The information processing apparatus according to any one of supplementary notes 1 to 5, wherein the state of the object includes a location of the object.

### (Supplementary Note 7)

The information processing apparatus according to any one of supplementary notes 1 to 6, wherein the set of sensor configurations includes at least one of a two-dimensional or three-dimensional location, direction, receiving sensitivity, and signal amplification factor, for each of the one or more sensors.

### (Supplementary Note 8)

The information processing apparatus according to any one of supplementary notes 1 to 7, wherein the representative statistic is an average value, a maximum value, a median, or a percentile value of the accuracy of estimation over a target space.

### (Supplementary Note 9)

A sensing system comprising:

the information processing apparatus according to any one of supplementary notes 1 to 8;

the one or more sensors; and

estimation apparatus configured to estimate the state of the object using the one or more sensors.

### (Supplementary Note 10)

A method comprising:

obtaining a spatial distribution model of accuracy of estimation related to a state of an object, performed using one or more sensors;

calculating a representative statistic for evaluating the accuracy of estimation based on the spatial distribution model obtained; and

determining an optimal set of sensor configurations for the one or more sensors based on the representative statistics calculated respectively for different sets of sensor configurations for the one or more sensors.

### (Supplementary Note 11)

A program that causes a processor to execute:

obtaining a spatial distribution model of accuracy of estimation related to a state of an object, performed using one or more sensors;

calculating a representative statistic for evaluating the accuracy of estimation based on the spatial distribution model obtained; and

determining an optimal set of sensor configurations for the one or more sensors based on the representative statistics calculated respectively for different sets of sensor configurations for the one or more sensors.

### (Supplementary Note 12)

A non-transitory computer readable recording medium storing a program that causes a processor to execute:

obtaining a spatial distribution model of accuracy of estimation related to a state of an object, performed using one or more sensors;

calculating a representative statistic for evaluating the accuracy of estimation based on the spatial distribution model obtained; and

determining an optimal set of sensor configurations for the one or more sensors based on the representative statistics calculated respectively for different sets of sensor configurations for the one or more sensors.

This application claims the priority on the basis of Japanese Patent Application No. 2018-194397, filed on Oct. 15, 2018, and its disclosure, including the specification, drawings and abstract, is incorporated herein by reference in its entirety.

### INDUSTRIAL APPLICABILITY

The technique according to the present disclosure can be used, but not limited to, for efficiently designing sensor configurations in a sensing system that attempts to estimate the state of an object by using sensors.

### REFERENCE SIGNS LIST

1 Sensing system
10 Target space
20 Estimation object
50 (50a-d) Sensor
60 Estimation server
100, 200 Design support apparatus (information processing apparatus)
110, 210 Processing unit
120 Storage section
130 Communication interface
140 User interface
150 Model obtaining section
160 Statistic calculation section
170 Optimization section
280 Number determining section

What is claimed is:

1. An information processing apparatus comprising:
a memory storing instructions; and
one or more processors configured to execute the instructions to:
obtain a spatial distribution model of accuracy of estimation related to a state of an object, performed using one or more sensors;
calculate a representative statistic for evaluating the accuracy of estimation based on the spatial distribution model obtained; and
determine an optimal set of sensor configurations for the one or more sensors based on representative statistics calculated respectively for different sets of sensor configurations for the one or more sensors.

2. The information processing apparatus according to claim 1, wherein the one or more processors are further configured to execute the instructions to determine the number of sensors to be arranged to estimate the state of the object, based on optimal sets of sensor configurations determined respectively for different numbers of sensors.

3. The information processing apparatus according to claim 2, wherein the one or more processors are configured to execute the instructions to determine whether the representative statistic corresponding to the optimal set of sensor configurations determined for each number of sensors fulfills a predetermined condition, to determine the number of sensors to be arranged.

4. The information processing apparatus according to claim 1, wherein the one or more processors are configured to execute the instructions to build the spatial model using a joint distribution of probability density distributions of measurement errors across a plurality of sensors, to obtain the spatial model.

5. The information processing apparatus according to claim 4, wherein the spatial distribution model is a function of a location of the object to give a lower bound of variance of errors depending on the joint distribution.

6. The information processing apparatus according to claim 1, wherein the state of the object includes a location of the object.

7. The information processing apparatus according to claim 1, wherein the set of sensor configurations includes at least one of a two-dimensional or three-dimensional location, direction, receiving sensitivity, and signal amplification factor, for each of the one or more sensors.

8. The information processing apparatus according to claim 1, wherein the representative statistic is an average value, a maximum value, a median, or a percentile value of the accuracy of estimation over a target space.

9. A sensing system comprising:
the information processing apparatus according to claim 1;
the one or more sensors; and
estimation apparatus configured to estimate the state of the object using the one or more sensors.

10. A method comprising:
obtaining a spatial distribution model of accuracy of estimation related to a state of an object, performed using one or more sensors;
calculating a representative statistic for evaluating the accuracy of estimation based on the spatial distribution model obtained; and
determining an optimal set of sensor configurations for the one or more sensors based on the representative statistics calculated respectively for different sets of sensor configurations for the one or more sensors.

11. (canceled)

12. A non-transitory computer readable recording medium storing a program that causes a processor to execute:
obtaining a spatial distribution model of accuracy of estimation related to a state of an object, performed using one or more sensors;
calculating a representative statistic for evaluating the accuracy of estimation based on the spatial distribution model obtained; and
determining an optimal set of sensor configurations for the one or more sensors based on the representative statistics calculated respectively for different sets of sensor configurations for the one or more sensors.
